(19) United States
(12) Patent Application Publication
(10) Pub. No.: US 2011/0317003 A1
(43) Pub. Date: Dec. 29, 2011

(54) METHOD AND SYSTEM FOR EDGE INSPECTION USING A TILTED ILLUMINATION

(76) Inventors: Roy PORAT, Kfar Yehoshua (IL); Yacov Malinovich, Kiryat Tivon (IL)

(21) Appl. No.: 13/113,095

(22) Filed: May 23, 2011

Related U.S. Application Data
(60) Provisional application No. 61/350,546, filed on Jun. 2, 2010.

(51) Int. Cl. H04N 7/18

(52) U.S. Cl. 348/126; 348/E07.085

(57) ABSTRACT

A method and an edge inspection system, the edge inspection system includes: an illumination unit; a support module for supporting an inspected object and for moving the inspected object in relation to the illumination unit; wherein the inspected object comprises a top surface, a bottom surface and at least one edge facet; an illumination unit that has an illumination axis, wherein the illumination unit is arranged to illuminate an inspected edge area of the inspected object by directing a light beam along the illumination axis; wherein the illumination axis is tilted in relation to a plane of the inspected object by a tilt angle that differs from ninety degrees; wherein the plane of the inspected object is defined by at least one of the top surface and the bottom surface; and a camera that has a collection axis, wherein the camera is arranged to detect light from the inspected edge area.

### RELATED APPLICATIONS

This application claims priority from U.S. provisional patent Ser. No. 61/350546, filing date Jun. 2, 2010, which is incorporated herein by reference.

### BACKGROUND OF THE INVENTION

Electrical circuits such as wafers or other flat electrical circuits include and edge that once inspected may reveal defects and other information that provide an indication about the quality of a manufacturing process of the electrical circuits.

### SUMMARY

According to an embodiment of the invention an edge inspection system may be provided and may include: an illumination unit; a support module for supporting an inspected object and for moving the inspected object in relation to the illumination unit; wherein the inspected object comprises a top surface, a bottom surface and at least one edge facet; an illumination unit that has an illumination axis, wherein the illumination unit is arranged to illuminate an inspected edge area of the inspected object by directing a light beam along the illumination axis; wherein the illumination axis is tilted in relation to a plane of the inspected object by a tilt angle that differs from ninety degrees; wherein the plane of the inspected object is defined by at least one of the top surface and the bottom surface; and a camera that has a collection axis, wherein the camera is arranged to detect light from the inspected edge area.

According to an embodiment of the invention a method for inspecting an edge area of an inspected object may be provided and may include: supporting an inspected object that comprises a top surface, a bottom surface and at least one edge facet; illuminating an inspected edge area of the inspected object by an illumination unit that has an illumination axis; wherein the illuminating comprises, directing a light beam along the illumination axis; wherein the illumination axis is tilted in relation to a plane of the inspected object by a tilt angle that differs from ninety degrees; wherein the plane of the inspected object is defined by at least one of the top surface and the bottom surface; and detecting, by a camera that has a collection axis, from the inspected edge area.

The projection of the collection axis on the plain of the inspected object may be parallel to a projection of the inspection axis on the plain of the inspected object.

The projection of the collection axis on the plain of the inspected object and a projection of the inspection axis on the plain of the inspected object may form a single line.

The projection of the collection axis on the plain of the inspected object may be oriented in relation to a projection of the inspection axis on the plain of the inspected object.

The projection of at least one of the camera and the illumination unit on the plain of the inspected object may be located within a projection of the inspected object on the plain of the inspected object.

The projection of the camera and the illumination unit on the plain of the inspected object may be located within a projection of the inspected object on the plain of the inspected object.

The projection of the camera and the illumination unit on the plain of the inspected object may be located within a projection of the inspected object on the plain of the inspected object.

The angle between the plane of the inspected object and the illumination axis may equal an angle between the plane of the inspected object and the collection axis.

The angle between the plane of the inspected object and the illumination axis may differ from an angle between the plane of the inspected object and the collection axis.

The camera may be positioned to detect light reflected from the inspected edge area.

The camera may be positioned to detect light scattered from the inspected edge area.

The camera may be positioned to detect light reflected from the inspected edge area and wherein the system comprises an additional camera arranged to detect light scattered from the inspected edge area.

The edge inspection system may include an additional illumination unit that has an additional illumination axis that is oriented in relation to the illumination axis of the illumination unit; wherein the camera is positioned to detect light reflected from the inspected edge area as a result of an illumination by the illumination unit and to detect light scattered from the inspected edge area as a result of an illumination by the additional illumination unit.

The edge inspection system may include an additional illumination unit that has an additional illumination axis that is oriented in relation to the illumination axis of the illumination unit; wherein the camera is positioned to detect light scattered from the inspected edge area as a result of an illumination by the illumination unit and to detect light reflected from the inspected edge area as a result of an illumination by the additional illumination unit.

The edge inspection system may include a processor arranged to detect defects based on detection signals generated by the camera in response to detected light.

The edge inspection system may include a processor arranged to perform measurements of an inspected edge area based on detection signals generated by the camera in response to detected light.

At least one of the cameras and the illumination units may be positioned at the plane of the inspected object.

The method may include detecting by the camera light reflected from the inspected edge area.

The method may include detecting by the camera light scattered from the inspected edge area.

The method may include detecting by the camera light reflected from the inspected edge area and detecting by an additional camera light scattered from the inspected edge area.

The method may include detecting by the camera light reflected from the inspected edge area as a result of an illumination by the illumination unit and detecting light scattered from the inspected edge area as a result of an illumination by an additional illumination unit that has an additional illumination axis that is oriented in relation to the illumination axis of the illumination unit.

The method may include detecting by the camera light scattered from the inspected edge area as a result of an illumination by the illumination unit and detecting light reflected from the inspected edge area as a result of an illumination by an additional illumination unit that has an additional illumination axis that is oriented in relation to the illumination axis of the illumination unit.

The method may include detecting by a processor defects based on detection signals generated by the camera in response to detected light.

The method may include performing measurements of an inspected edge area based on detection signals generated by the camera in response to detected light.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1-23 illustrate an inspected object and portions of an edge inspection system according to various embodiments of the invention;

FIG. 24 illustrates a method according to an embodiment of the invention;

FIGS. 25-33 illustrate an inspected object and portions of an edge inspection system according to various embodiments of the invention;

FIG. 34 illustrates a portion of an inspected object; and

FIGS. 35-37 illustrate inspected edge areas according to various embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

An optical inspection system and a method are provided. The inspection system and method can detect defects that are close to the edge of an inspected object (such as but not limited to a wafer). The system may include an illumination unit that illuminates an edge area of the inspected object at an angle that differs from ninety degrees in relation to a plane of the wafer. The illumination unit can include a light source and may include optics such but not limited to one or more lenses. According to an embodiment of the invention the illumination unit includes a light source and zero or more lenses.

According to an embodiment of the invention the illumination unit has an illumination axis and a projection of the illumination axis on a plane of the inspected object is oriented in relation to an imaginary tangent line that is tangent to the edge area by an angle that differs from ninety degrees.

The system may include one of more cameras. The one or more cameras may include at least zero cameras for collecting reflected light (bright field camera) and at least zero cameras for collecting scattered light (dark field cameras).

According to various embodiments of the invention the one or more cameras are located directly above (or directly below) the plane of the inspected object so that a projection of the one or more cameras on the plane of the inspected object falls on the inspected object.

According to various embodiments of the invention the one or more cameras are not located directly above (or directly below) the plane of the inspected object so that a projection of the one or more cameras on the plane of the inspected object falls outside the inspected object.

According to an embodiment of the invention the illumination unit illuminates the inspected edge area by a single light beam.

According to an embodiment of the invention the illumination unit illuminates the inspected edge area by multiple light beams that are substantially parallel to each other.

The system and method can be utilized for various purposes (applications) such as but not limited to detection of defects of various sizes, down to micron level defects in the top, top near edge, apex, bottom near edge and bottom surfaces at the periphery of thin substrates, such as wafers used in the production of semiconductor or MEMS devices, or solar cells.

The mentioned above illumination scheme can be referred to as tilted illumination. It may emphasize defects or structural feature of the inspected object. For example, at the absence of diffusive illumination various potential defects with slope on the surface of the inspected object (including edge) that have specular reflection characteristic will not return the light into the camera and will appear as black pixels. Yet for example, when the edge area of the inspected object has multiple smooth facets with specular reflection characteristic and they are oriented in relation to each other (and also to the plane of the inspected object) then the border between these facets can be emphasized by black borders if the specular reflections are out of the camera optics.. Yet for another example events (such as potential defects and structural elements of the inspected object) on the surface of the inspected object which are or higher (protruding) or dipper (sagging) than the surface (on edge area facet) of the inspected object may also appear as black pixels because the structural element reflection is specular.

In general, by specific image acquisition configuration (various combination between optical axes of camera, illuminators and illuminations axes critical defects and edge area facets (zone borders) may appear as black pixels and as result be easier for recognition—thus reducing a number of false calls, make system more reliable and easier from the algorithms point of view.

According to an embodiment of the invention the tilted illumination may assist in obtaining bright field (reflected) images without using a beam combiner (beam splitter) in the imaging optical path and therefore without the distortions that such beam combiner (beam splitter) can introduce.

It is noted that any combination of any stage of any method (or methods) illustrated below can be provided.

It is noted that any combination of any component of any system (or systems) illustrated below can be provided.

For simplicity of explanation, some of the following figures refer to a wafer. It is noted that other inspected objects (such as but not limited to a thin substrate) can be inspected by either one of the below mentioned systems and by either one of the below mentioned methods.

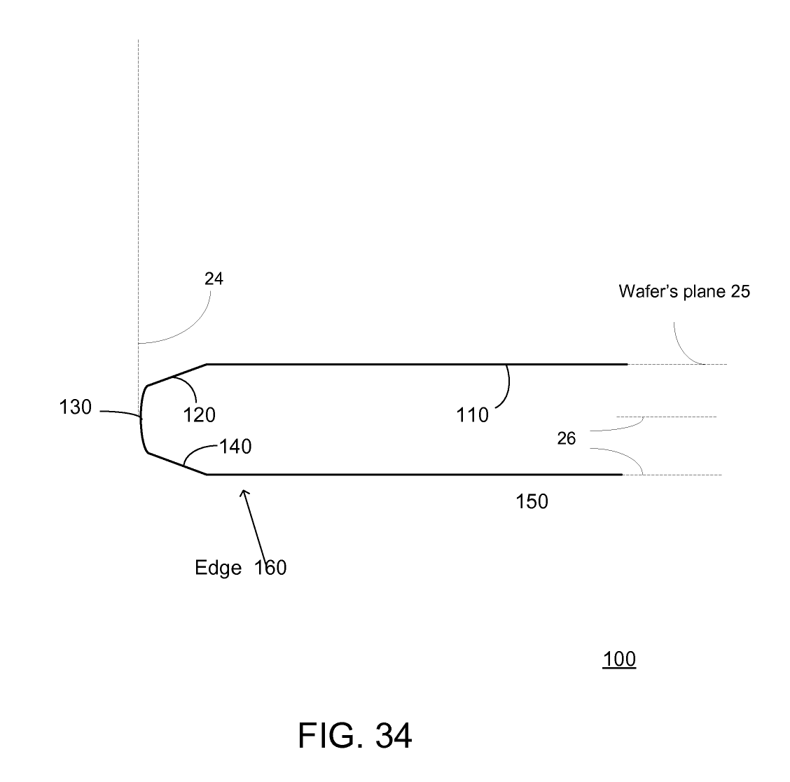

FIG. 34 depicts a cross section of an edge 160 of an inspected object such as wafer 100.

Edge 160 of wafer 100 includes five surfaces (facets) of interest that the method and system can inspect simultaneously—top facet 110, top bevel facet 120, apex 130, bottom bevel facet 140 and bottom facet 150. It is noted that top facet 110 and bottom facet 150 can extend out of edge 160. For simplicity of explanation they (150 and 160) are viewed as including only portions of these facets that are proximate to apex 130.

It is noted that the below mentioned methods and systems can be applied mutatis mutandis to inspect objects having fewer surfaces of interest, such as having a rectangular cross section, or more.

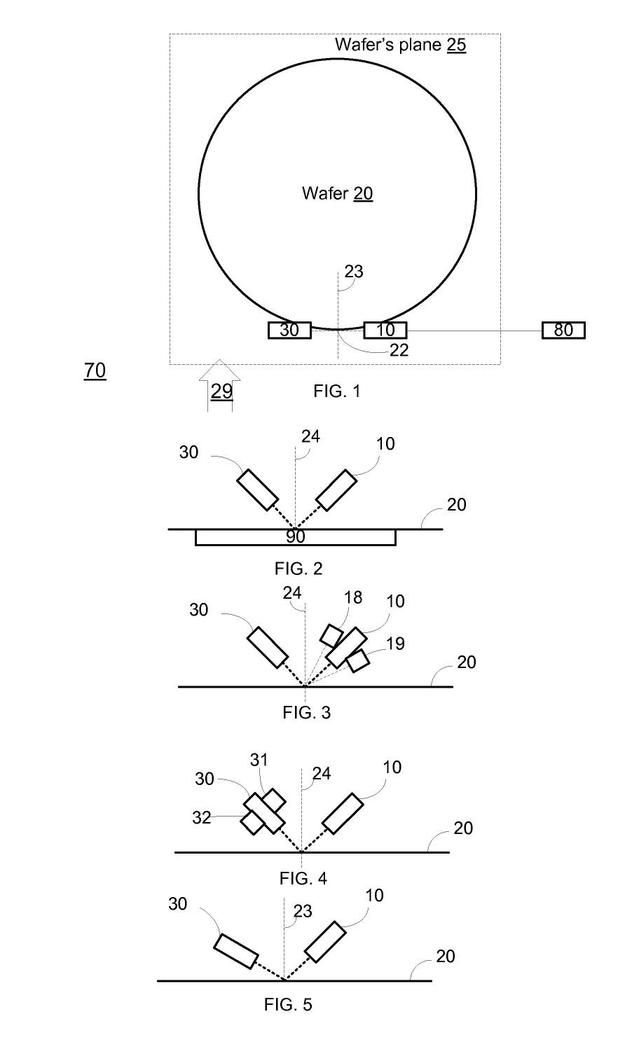

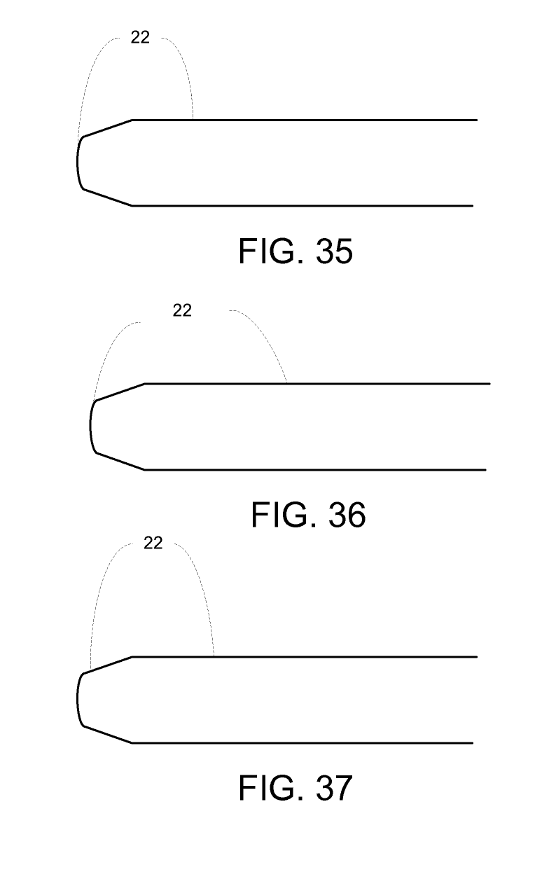

An inspected edge area (such as inspected edge area 22 of FIGS. 1,6,11, 16, 21, 23, 25, 27 and 32) can include a portion of the edge 160. FIGS. 35-37 illustrate various examples of inspected edge areas that differ from each other by size and also by the facets included in each inspected edge area. Only for simplicity of explanation these figures do not show inspected edge areas that include a portion of the bottom facet 150 and the bottom bevel facet 140.

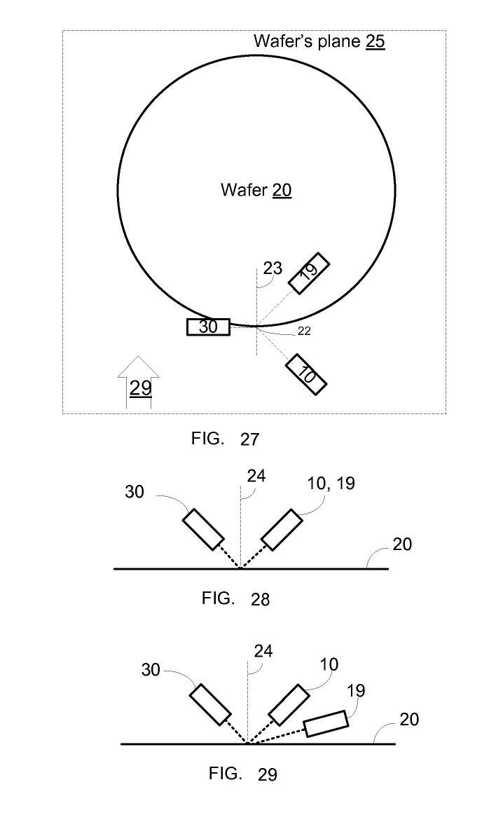

For example, FIGS. 1-29 illustrate an illumination unit 30 and camera 10 that are positioned above the wafers plane 25 so that the camera 10 can detect light scattered or reflected (or both) from top facet 110, top bevel facet 120, and apex 130 or a combination thereof. It is noted that in certain arrangements only one of the camera 10 and the illumination unit 30 is positioned above the wafers plane 25 in order to allow the camera 10 to detect scattered or reflected (or both) from top facet 110, top bevel facet 120, and apex 130 or a combination thereof.

It is noted that at least one out of camera 10 and illumination unit 30 (or both) can be positioned at the wafers plane 25. Additionally or alternatively, at least one of camera 10 and illumination unit 30 (or both) can be positioned below the wafers plane 25. These latter configurations may allow the camera 10 to detect light scattered or reflected from bottom bevel facet 140, bottom facet 160 or both (and also from apex 130) the camera should be positioned below the wafer 20.

System 70 can also include at least one of the following components: memory unit, processor (such as image processor), supporting elements such as a stage, and the like. If, for example the inspected object is circular the stage can rotate the object about a central axis.

FIG. 1 illustrates a processor 80 that is connected to the camera and FIG. 2 illustrates a supporting element such as stage 90 that supports the inspected object 20. A memory unit can store detection signals and send them to the processor 80.

FIGS. 1-33 illustrate wafer 20 and various portions of system 70 according various embodiments of the invention. The wafer 20 is illustrated as being horizontal—it is positioned in a horizontal plane denoted wafers plane 25. The wafers plane 25 can be defined by the upper facet 110 of the wafer 20, the lower facet of the wafer 150 or be parallel but spaced apart from these facets (110, 150)—as illustrated by dashed lines 25 and 26 of FIG. 34.

FIG. 1 is a top view of wafer 20, camera 10, illumination unit 30 and a processor 80 according to an embodiment of the invention. FIGS. 2-5 are side views of the wafer 20 and various portions of the system 70 according to various embodiments of the invention. FIGS. 2-5 are taken from a direction that is illustrated by arrow 29 of FIG. 1.

Camera 10 and illumination unit 30 are illustrated as being positioned at opposite sides of an imaginary radial line 23 that ends at the inspected edge area 22. The projection of the collection axis (of the camera 10) on the wafers plane 25 and the projection of the illumination axis (of the illumination unit 30) on the wafers plane 25 form a straight line that is tangent to the inspected edge area 22.

Both camera 10 and illumination unit 30 are not positioned directly above wafer 20—their projection at the wafers plane 25 falls outside the projection of the wafer 20 at the wafers plane.

According to other embodiments of the invention the projection of the collection axis (of the camera 10) on the wafers plane 25 and the projection of the illumination axis (of the illumination unit 30) on the wafers plane 25 may form a straight line that oriented in relation to an imaginary tangent to the inspected edge area 22. This can be obtained if, for example, only one of the camera 10 and the illumination unit 30 is positioned directly above (or below) the wafer 20.

The camera 10 and the illumination unit 30 can be positioned in relation to each other such that the camera will collect reflected light from the inspected edge area (as illustrated for example in FIG. 2). Thus, the angle between a normal axis 23 (that is normal to the wafer's plane) and the illumination axis equals the angle between the normal axis 23 and the collection axis.

FIG. 3 illustrates camera 10 and two additional cameras 18 and 19. While camera 10 detects reflected light from the inspected edge area 22, cameras 18 and 19 are arranged to collect scattered light from the inspected edge area 22. It is noted that the collection axes of cameras 18 and 19 differ from the collection axis of camera 20.

FIG. 4 illustrates camera 10, illumination unit 30 and additional illumination units 31 and 32. The camera 10 and the illumination units 30-32 are positioned so that the camera 10 receives (a) reflected light due to the illumination of the inspected edge area 22 by illumination unit 30, (b) scattered light due to the illumination of the inspected edge area 22 by additional illumination unit 31, and (c) scattered light due to the illumination of the inspected edge area 22 by additional illumination unit 32.

Alternatively, the camera 10 and the illumination unit 30 can be positioned in relation to each other such that the camera will collect scattered light from the inspected edge area—as illustrated for example in FIG. 5. Thus, the angle between a normal axis 23 (that is normal to the wafers plane) and the illumination axis differs from the angle between the normal axis 23 and the collection axis.

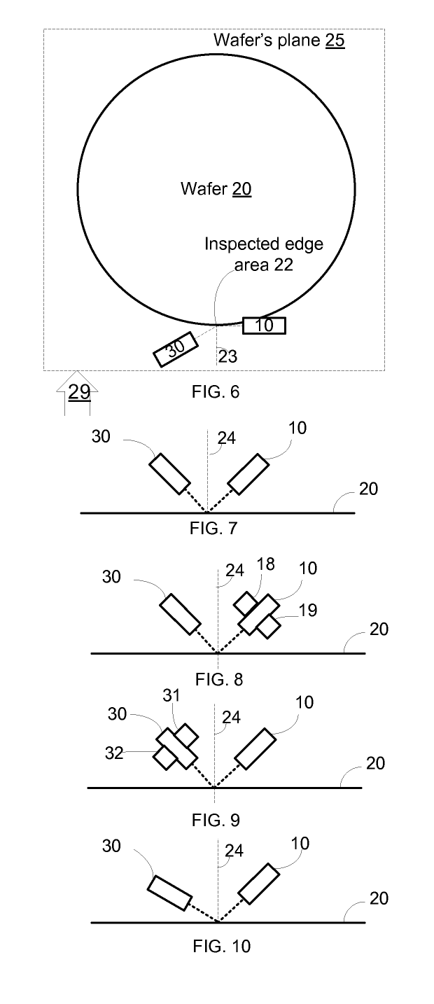

FIG. 6 is a top view of wafer 20, camera 10 and illumination unit 30 according to an embodiment of the invention. FIGS. 7-10 are side views of the wafer 20 and various portions of the system 70 according to various embodiments of the invention. FIGS. 7-10 are taken from a direction that is illustrated by arrow 29 of FIG. 6.

FIG. 6 illustrates camera 10 as arranged to detect scattered light from the inspected edge area. The projections (on the wafers plane 25) of the collection axis and of the illumination axis are not-parallel to each other. The projection (on the wafers plane 25) of the collection axis is tangent to the wafer 20 while the projections (on the wafers plane 25) of the illumination axis is neither tangent or normal to the inspected edge area 22.

Both camera 10 and illumination unit 30 are not positioned directly above wafer 20—their projection at the wafers plane 25 falls outside the projection of the wafer 20 at the wafers plane.

FIG. 7 illustrates an angle between a normal axis 23 (that is normal to the wafers plane) and the illumination axis that is equal to the angle between the normal axis 23 and the collection axis.

FIG. 8 illustrates camera 10 and two additional cameras 18 and 19. All cameras (10, 18 and 19) differ by their collection axis but all detect scattered light from the inspected edge area 22.

FIG. 9 illustrates illumination unit 30 and two additional illumination units 31 and 32. All illumination units 30-32 differ by their illumination axes but all illuminate the inspected edge area 22.

FIG. 10 illustrates an angle between a normal axis 23 (that is normal to the wafers plane) and the illumination axis that differs from the angle between the normal axis 23 and the collection axis.

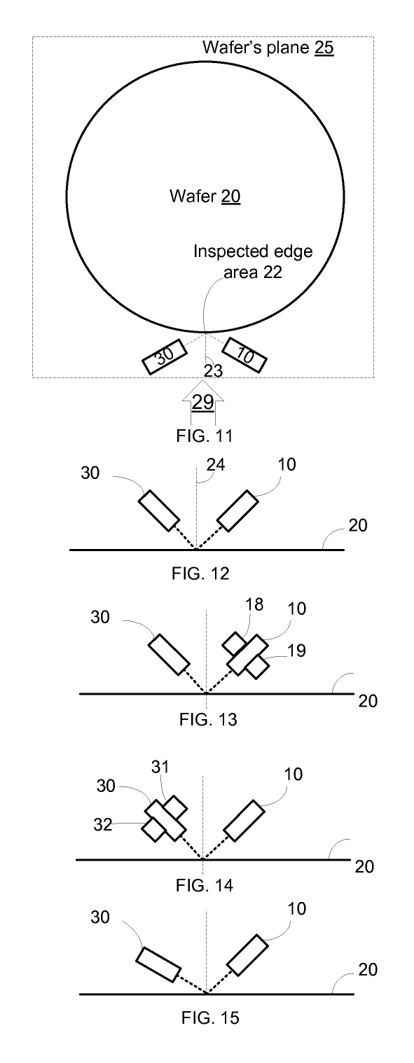

FIG. 11 is a top view of wafer 20, camera 10 and illumination unit 30 according to an embodiment of the invention. FIGS. 12-15 are side views of the wafer 20 and various portions of the system 70 according to various embodiments of the invention. FIGS. 12-15 are taken from a direction that is illustrated by arrow 29 of FIG. 11.

FIG. 11 illustrates camera 10 as arranged to detect scattered light from the inspected edge area. The projections (on the wafers plane 25) of the collection axis and of the illumination axis are not-parallel to each other. The projections (on the wafers plane 25) of the collection axis and of the illumination axis are oriented (not tangent and not normal).

Both camera 10 and illumination unit 30 are not positioned directly above wafer 20—their projection at the wafers plane 25 falls outside the projection of the wafer 20 at the wafers plane.

FIG. 12 illustrates an angle between a normal axis 23 (that is normal to the wafers plane) and the illumination axis that is equal to the angle between the normal axis 23 and the collection axis.

FIG. 13 illustrates camera 10 and two additional cameras 18 and 19. All cameras differ by their collection axis but all detect scattered light from the inspected edge area 22.

FIG. 14 illustrates illumination unit 30 and two additional illumination units 31 and 32. All illumination units 30-32 differ by their illumination axes but all illuminate the inspected edge area 22.

FIG. 15 illustrates an angle between a normal axis 23 (that is normal to the wafers plane) and the illumination axis that differs from the angle between the normal axis 23 and the collection axis.

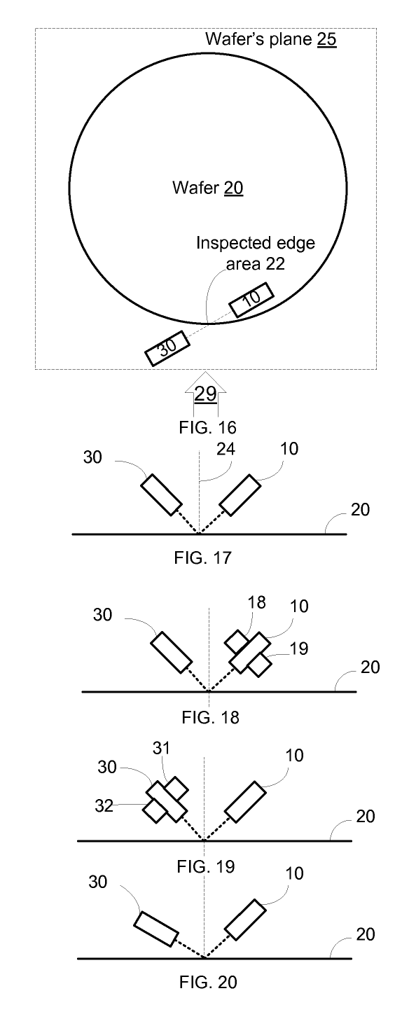

FIG. 16 is a top view of wafer 20, camera 10, illumination unit 30 and a processor 80 according to an embodiment of the invention. FIGS. 17-20 are side views of the wafer 20 and various portions of the system 70 according to various embodiments of the invention. FIGS. 17-20 are taken from a direction that is illustrated by arrow 29 of FIG. 16.

Camera 10 and illumination unit 30 are illustrated as being positioned at opposite sides of an imaginary radial line 23 that ends at the inspected edge area 22. The projection of the collection axis (of the camera 10) on the wafers plane 25 and the projection of the illumination axis (of the illumination unit 30) on the wafers plane 25 form a straight line that is oriented to the inspected edge area 22 but is neither normal or tangent to the inspected edge area 22.

FIG. 16 illustrates camera 10 as being positioned directly above the wafer and the illumination unit 30 as not being positioned directly above wafer 20. The projection of the camera 10 on the wafers plane 25 falls on the projection of the wafer 20 while the projection of the illumination unit 30 at the wafers plane 25 falls outside the projection of the wafer 20 at the wafers plane 25.

The camera 10 and the illumination unit 30 can be positioned in relation to each other such that the camera will collect reflected light from the inspected edge area (as illustrated for example in FIG. 17). Thus, the angle between a normal axis 23 (that is normal to the wafer's plane) and the illumination axis equals the angle between the normal axis 23 and the collection axis.

FIG. 18 illustrates camera 10 and two additional cameras 18 and 19. While camera 10 detects reflected light from the inspected edge area 22, cameras 18 and 19 are arranged to collect scattered light from the inspected edge area 22. It is noted that the collection axes of cameras 18 and 19 differ from the collection axis of camera 20.

FIG. 19 illustrates camera 10, illumination unit 30 and additional illumination units 31 and 32. The camera 10 and the illumination units 30-32 are positioned so that the camera 10 receives (a) reflected light due to the illumination of the inspected edge area 22 by illumination unit 30, (b) scattered light due to the illumination of the inspected edge area 22 by additional illumination unit 31, and (c) scattered light due to the illumination of the inspected edge area 22 by additional illumination unit 32.

Alternatively, the camera 10 and the illumination unit 30 can be positioned in relation to each other such that the camera will collect scattered light from the inspected edge area—as illustrated for example in FIG. 20. Thus, the angle between a normal axis 23 (that is normal to the wafers plane) and the illumination axis differs from the angle between the normal axis 23 and the collection axis.

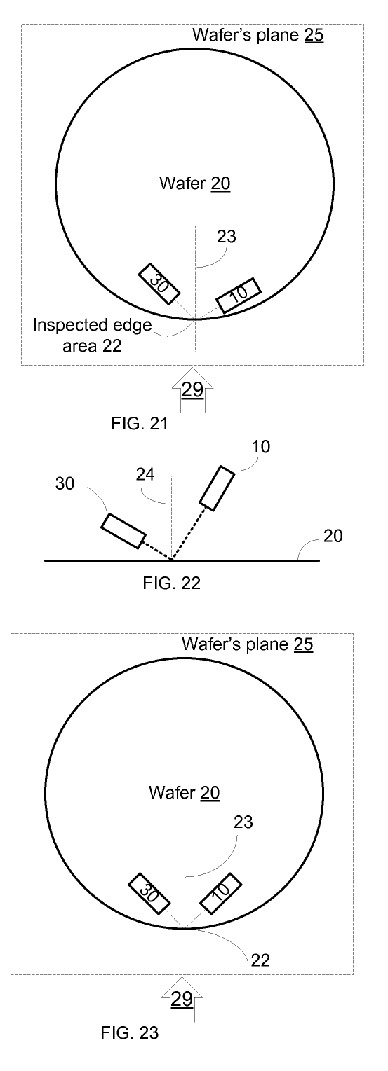

FIG. 21 is a top view of wafer 20, camera 10 and illumination unit 30 according to an embodiment of the invention. FIG. 22 is a side view of the wafer 20 and various portions of the system 70 according to an embodiment of the invention. FIG. 21 is taken from a direction that is illustrated by arrow 29 of FIG. 21.

FIG. 21 illustrates camera 10 as arranged to detect scattered light from the inspected edge area. The projections (on the wafers plane 25) of the collection axis and of the illumination axis are not-parallel to each other. The projections (on the wafers plane 25) of the collection axis and of the illumination axis are oriented (not tangent and not normal). The projection of the illumination axis (on the wafers plane 25) and projection of the collection axis (on the wafers plane 25) are non-symmetrical in relation to a radial axis 23 that stretches from a center of wafer 20 to the inspected edge area 22.

Both camera 10 and illumination unit 30 are positioned directly above wafer 20—their projection at the wafers plane 25 falls within the projection of the wafer 20 at the wafers plane 25.

FIG. 22 illustrates an angle between a normal axis 23 (that is normal to the wafers plane) and the illumination axis that is equal to the angle between the normal axis 23 and the collection axis.

FIG. 23 illustrates camera 10 as arranged to detect scattered light from the inspected edge area. The projections (on the wafers plane 25) of the collection axis and of the illumination axis are not-parallel to each other. The projections (on the wafers plane 25) of the collection axis and of the illumination axis are oriented (not tangent and not normal). The projection of the illumination axis (on the wafers plane 25) and projection of the collection axis (on the wafers plane 25) are symmetrical in relation to a radial axis 23 that stretches from a center of wafer 20 to the inspected edge area 22.

Both camera 10 and illumination unit 30 are positioned directly above wafer 20—their projection at the wafers plane 25 falls within the projection of the wafer 20 at the wafers plane 25.

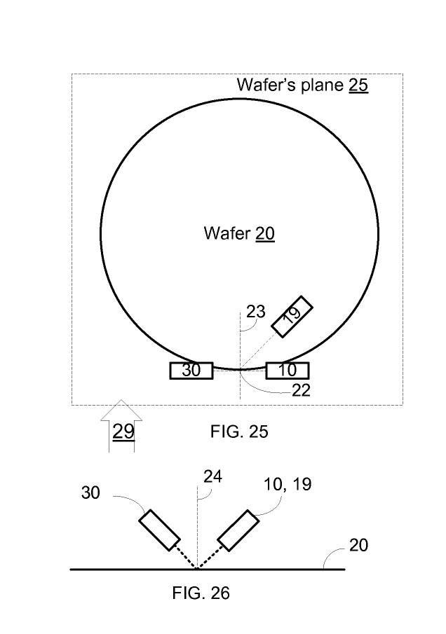

FIG. 25 is a top view of wafer 20, camera 10, additional camera 19 and illumination unit according to an embodiment of the invention. FIG. 26 is a side view of the wafer 20 and various portions of the system 70 according to an embodiment of the invention. FIG. 26 is taken from a direction that is illustrated by arrow 29 of FIG. 25.

Camera 10 and illumination unit 30 are illustrated as being positioned at opposite sides of an imaginary radial line 23 that ends at the inspected edge area 22. The projection of the collection axis (of the camera 10) on the wafers plane 25 and the projection of the illumination axis (of the illumination unit 30) on the wafers plane 25 form a straight line that is tangent to the inspected edge area 22. The projection of the additional collection axis of additional camera 19 on the wafers plane 25 is oriented to both the projections (on the wafers plane 25) of the illumination axis and of the collection axis of camera 10.

Both camera 10 and illumination unit 30 are not positioned directly above wafer 20—their projection at the wafers plane 25 falls outside the projection of the wafer 20 at the wafers plane. The additional camera 19 is positioned directly above wafer 20—its projection at the wafers plane 25 falls inside the projection of the wafer 20 at the wafers plane 25.

The camera 10 and the illumination unit 30 are positioned in relation to each other such that the camera 10 will collect reflected light from the inspected edge area (as illustrated for example in FIG. 26). Thus, the angle between a normal axis 23 (that is normal to the wafer's plane) and the illumination axis equals the angle between the normal axis 23 and the collection axis. It is noted that although the angle between the normal axis 23 and the illumination axis equals the angle between the normal axis 23 and the collection axis of the additional camera 19—the additional camera 19 detects scattered light.

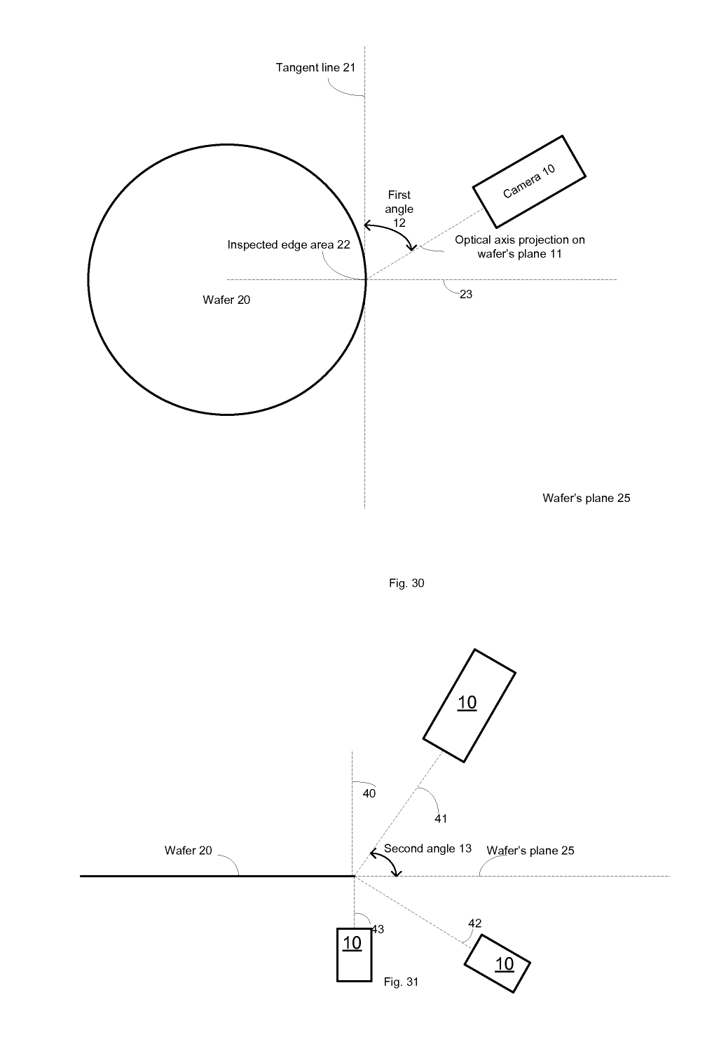

FIG. 29 illustrates the additional camera 19 as being lower than camera. The angle between the normal axis 23 and the illumination axis differs from the angle between the normal axis 23 and the collection axis of the additional camera 19.

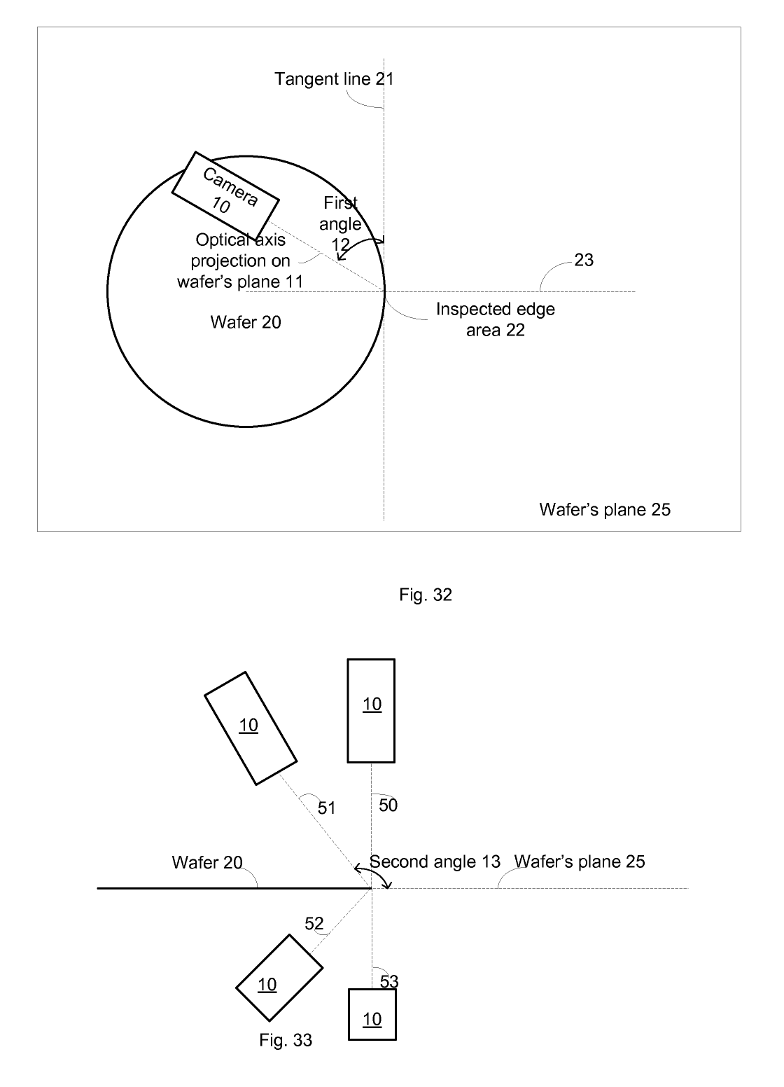

FIGS. 30 and 32 are top views of a wafer 20 that is being inspected by a camera 10.

FIGS. 30 and 32 differ from each other by the relative position of camera 10 in relation to wafer 20. In FIG. 32 the camera is located above the wafer 20 while in FIG. 30 the camera is not located above wafer 20.

The wafer 20 is positioned in an imaginary plane denoted wafers plane 25. An inspected edge area 22 of the wafer is being imaged by camera 10 that has an optical axis.

A projection of the optical axis of the camera on the wafers plane 25 (hereinafter—“projection”) 11 and a tangent line that is tangent to the inspected edge area 22 are not perpendicular to each other. A first angle 12 formed between projection 11 and tangent line 21 differs from ninety degrees. It may, for example, range between 10-80 degrees, between 5-40 degrees and the like.

The camera can be higher than the wafer, lower than the wafer, or at the same height as the wafer. A second angle 13 formed between the wafers plane 25 and the optical axis may range between almost zero to almost 360 degrees. This is illustrated by FIGS. 6 and 8 that are side view of wafer 20, wafers plane 25.

FIG. 31 shows few possible optical axes (few possible collection axes) 40, 41, 42 and 43 of the camera 10 while FIG. 33 shows few other optical axes (few possible collection axes) 50, 51, 52 and 53 of the camera 20.

For simplicity of explanation the figures does not illustrate various other components of an inspection system such as illumination optics, image processor, control, mechanical stage, and the like. The illumination can include pulsed illumination, continuous illumination, bright field illumination and dark field illumination. The system may include more than a single camera, wherein at least one camera is positioned as illustrated in FIGS. 30-34 while other cameras may provide other types (bright field, dark field) of collection.

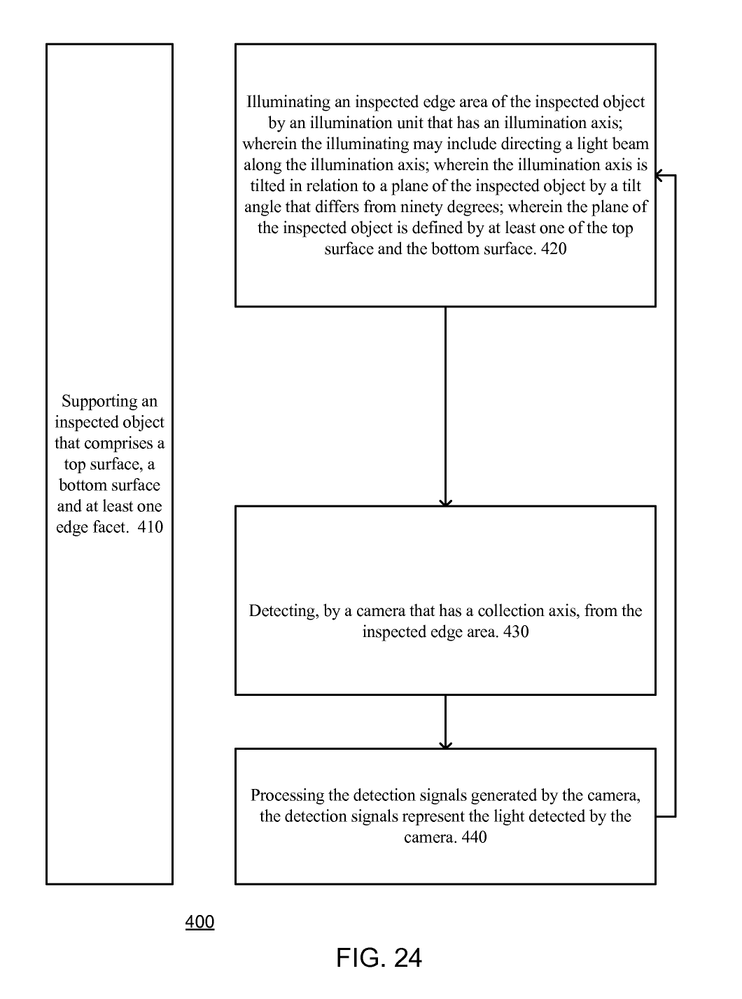

FIG. 24 illustrates a method 400 according to an embodiment of the invention.

Method 400 includes stage 410 of supporting an inspected object that comprises a top surface, a bottom surface and at least one edge facet. Stage 410 can include moving the inspected object in relation to an illumination unit and additionally or alternatively in relation to a camera. This movement can assist in imaging one inspected edge area after the other. For example, a disk shaped inspected object can have an annular shape edge area and portions of that annular shaped edge area (referred to inspected edge area) are images on e after the other by introducing rotational movement (or a linear approximation of such movement) between the wafer and at least one of the camera and the illumination unit.

Method 400 also includes stages 420, 430 and 440. Multiple iterations of stages 420 and 430 may occur while stage 410 is executed.

Stage 420 includes illuminating an inspected edge area of the inspected object by an illumination unit that has an illumination axis; wherein the illuminating may include directing a light beam along the illumination axis; wherein the illumination axis is tilted in relation to a plane of the inspected object by a tilt angle that differs from ninety degrees; wherein the plane of the inspected object is defined by at least one of the top surface and the bottom surface.

Stage 420 may be followed by stage 430 of detecting, by a camera that has a collection axis, from the inspected edge area.

Stager 430 may be followed by stage 440 of processing the detection signals generated by the camera, the detection signals represent the light detected by the camera.

At least one of the camera and the illumination unit is positioned at the plane of the inspected object.

The projection of the collection axis on the plain of the inspected object may be parallel to a projection of the inspection axis on the plain of the inspected object.

The projection of the collection axis on the plain of the inspected object and a projection of the inspection axis on the plain of the inspected object may form a single line.

The projection of the collection axis on the plain of the inspected object may be oriented in relation to a projection of the inspection axis on the plain of the inspected object.

The projection of at least one of the camera and the illumination unit on the plain of the inspected object may be located within a projection of the inspected object on the plain of the inspected object.

The projection of the camera and the illumination unit on the plain of the inspected object may be located within a projection of the inspected object on the plain of the inspected object.

The projection of the camera and the illumination unit on the plain of the inspected object may be located within a projection of the inspected object on the plain of the inspected object.

The angle between the plane of the inspected object and the illumination axis may equal an angle between the plane of the inspected object and the collection axis.

The angle between the plane of the inspected object and the illumination axis may differ from an angle between the plane of the inspected object and the collection axis.

Stage 430 may include detecting by the camera light reflected from the inspected edge area.

Stage 430 may include detecting by the camera light scattered from the inspected edge area.

Stage 430 may include detecting by the camera light reflected from the inspected edge area and detecting by an additional camera light scattered from the inspected edge area.

Stage 430 may include detecting by the camera light reflected from the inspected edge area as a result of an illumination by the illumination unit and detecting light scattered from the inspected edge area as a result of an illumination by an additional illumination unit that has an additional illumination axis that is oriented in relation to the illumination axis of the illumination unit.

Stage 430 may include detecting by the camera light scattered from the inspected edge area as a result of an illumination by the illumination unit and detecting light reflected from the inspected edge area as a result of an illumination by an additional illumination unit that has an additional illumination axis that is oriented in relation to the illumination axis of the illumination unit.

Stage 440 may include detecting by a processor defects based on detection signals generated by the camera in response to detected light.

Stage 440 may include performing measurements of an inspected edge area based on detection signals generated by the camera in response to detected light.

The present invention can be practiced by employing conventional tools, methodology, and components. Accordingly, the details of such tools, component, and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An edge inspection system, comprising:
an illumination unit;
a support module for supporting an inspected object and for moving the inspected object in relation to the illumination unit; wherein the inspected object comprises a top surface, a bottom surface and at least one edge facet;
an illumination unit that has an illumination axis, wherein the illumination unit is arranged to illuminate an inspected edge area of the inspected object by directing a light beam along the illumination axis;
wherein the illumination axis is tilted in relation to a plane of the inspected object by a tilt angle that differs from ninety degrees; wherein the plane of the inspected object is defined by at least one of the top surface and the bottom surface; and
a camera that has a collection axis, wherein the camera is arranged to detect light from the inspected edge area.

2. The edge inspection system according to claim 1, wherein a projection of the collection axis on the plain of the inspected object is parallel to a projection of the inspection axis on the plain of the inspected object.

3. The edge inspection system according to claim 1, wherein a projection of the collection axis on the plain of the inspected object and a projection of the inspection axis on the plain of the inspected object form a single line.

4. The edge inspection system according to claim 1, wherein a projection of the collection axis on the plain of the inspected object is oriented in relation to a projection of the inspection axis on the plain of the inspected object.

5. The edge inspection system according to claim 1, wherein a projection of at least one of the camera and the illumination unit on the plain of the inspected object is located within a projection of the inspected object on the plain of the inspected object.

6. The edge inspection system according to claim 1, wherein a projection of the camera and the illumination unit on the plain of the inspected object is located within a projection of the inspected object on the plain of the inspected object.

7. The edge inspection system according to claim 1, wherein a projection of the camera and the illumination unit on the plain of the inspected object is located within a projection of the inspected object on the plain of the inspected object.

8. The edge inspection system according to claim 1, wherein an angle between the plane of the inspected object and the illumination axis equals an angle between the plane of the inspected object and the collection axis.

9. The edge inspection system according to claim 1, wherein an angle between the plane of the inspected object and the illumination axis differs from an angle between the plane of the inspected object and the collection axis.

10. The edge inspection system according to claim 1, wherein the camera is positioned to detect light reflected from the inspected edge area.

11. The edge inspection system according to claim 1, wherein the camera is positioned to detect light scattered from the inspected edge area.

12. The edge inspection system according to claim 1, wherein the camera is positioned to detect light reflected from the inspected edge area and wherein the system comprises an additional camera arranged to detect light scattered from the inspected edge area.

13. The edge inspection system according to claim 1, comprising an additional illumination unit that has an additional illumination axis that is oriented in relation to the illumination axis of the illumination unit; wherein the camera is positioned to detect light reflected from the inspected edge area as a result of an illumination by the illumination unit and to detect light scattered from the inspected edge area as a result of an illumination by the additional illumination unit.

14. The edge inspection system according to claim 1, comprising an additional illumination unit that has an additional illumination axis that is oriented in relation to the illumination axis of the illumination unit; wherein the camera is positioned to detect light scattered from the inspected edge area as a result of an illumination by the illumination unit and to detect light reflected from the inspected edge area as a result of an illumination by the additional illumination unit.

15. The edge inspection system according to claim 1, comprising a processor arranged to detect defects based on detection signals generated by the camera in response to detected light.

16. The edge inspection system according to claim 1, comprising a processor arranged to perform measurements of an inspected edge area based on detection signals generated by the camera in response to detected light.

17. The edge inspection system according to claim 1, wherein at least one of the cameras and the illumination units are positioned at the plane of the inspected object.

18. A method for inspecting an edge area of an inspected object, the method comprises:
supporting an inspected object that comprises a top surface, a bottom surface and at least one edge facet;
illuminating an inspected edge area of the inspected object by an illumination unit that has an illumination axis; wherein the illuminating comprises, directing a light beam along the illumination axis; wherein the illumination axis is tilted in relation to a plane of the inspected object by a tilt angle that differs from ninety degrees; wherein the plane of the inspected object is defined by at least one of the top surface and the bottom surface; and
detecting, by a camera that has a collection axis, from the inspected edge area.

19. The method according to claim 18, wherein a projection of the collection axis on the plain of the inspected object is parallel to a projection of the inspection axis on the plain of the inspected object.

20. The method according to claim 18, wherein a projection of the collection axis on the plain of the inspected object and a projection of the inspection axis on the plain of the inspected object form a single line.

21. The method according to claim 18, wherein a projection of the collection axis on the plain of the inspected object is oriented in relation to a projection of the inspection axis on the plain of the inspected object.

22. The method according to claim 18, wherein a projection of at least one of the cameras and the illumination unit on the plain of the inspected object is located within a projection of the inspected object on the plain of the inspected object.

23. The method according to claim 18, wherein a projection of the camera and the illumination unit on the plain of the inspected object is located within a projection of the inspected object on the plain of the inspected object.

24. The method according to claim 18, wherein a projection of the camera and the illumination unit on the plain of the inspected object is located within a projection of the inspected object on the plain of the inspected object.

25. The method according to claim 18, wherein an angle between the plane of the inspected object and the illumination axis equals an angle between the plane of the inspected object and the collection axis.

26. The method according to claim 18, wherein an angle between the plane of the inspected object and the illumination axis differs from an angle between the plane of the inspected object and the collection axis.

27. The method according to claim 18, comprising detecting by the camera light reflected from the inspected edge area.

28. The method according to claim 18, comprising detecting by the camera light scattered from the inspected edge area.

29. The method according to claim 18, comprising detecting by the camera light reflected from the inspected edge area and detecting by an additional camera light scattered from the inspected edge area.

30. The method according to claim 18, comprising detecting by the camera light reflected from the inspected edge area as a result of an illumination by the illumination unit and detecting light scattered from the inspected edge area as a result of an illumination by an additional illumination unit that has an additional illumination axis that is oriented in relation to the illumination axis of the illumination unit.

31. The method according to claim 18, comprising detecting by the camera light scattered from the inspected edge area as a result of an illumination by the illumination unit and detecting light reflected from the inspected edge area as a result of an illumination by an additional illumination unit that has an additional illumination axis that is oriented in relation to the illumination axis of the illumination unit.

32. The method according to claim 18, comprising detecting by a processor defects based on detection signals generated by the camera in response to detected light.

33. The method according to claim 18, comprising performing measurements of an inspected edge area based on detection signals generated by the camera in response to detected light.

34. The method according to claim 18, wherein at least one of the cameras and the illumination unit are positioned at the plane of the inspected object.
